(19) United States
(12) Patent Application Publication
(10) Pub. No.: US 2007/0246510 A1
(43) Pub. Date: Oct. 25, 2007

(54) Rotating type soldering device

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/399,321

(22) Filed: Apr. 7, 2006

(51) Int. Cl. A47J 36/02

(52) U.S. Cl. 228/101

(57) ABSTRACT

A rotating type soldering device is used for soldering a heat pipe and includes a transmission mechanism having a transmission platform on which heat pipes are disposed and transmitted. A rotation mechanism and a material-sending mechanism are arranged on topside and bottom side of the transmission platform The rotation mechanism includes a pair of rolling wheels rotated in the same direction. The material-sending mechanism includes a feeding rod used to push the heat pipe to move toward the rolling wheels and drive the heat pipe to have rotational contact with the rolling wheels. A solder mechanism is arrange on one side of the heat pipe and includes a solder gun corresponding to one end of the heat pipe and having a height difference with the transmission platform. The solder gun solders an opening of the heat pipe when the heat pipe is in rotational contact with the rolling wheels.

### BACKGROUND OF THE INVENTION

1. Field of the Invention

The present invention relates to a rotating type soldering device, especially to a rotating type soldering device for sealing opening end of heat pipe when the rolling wheels are in rotational contact with the heat pipe.

2. Description of Prior Art

The heat pipes are extensively used for heat dissipation in electronic devices because the heat pipes have advantages of high and fast thermal transmission ability, high thermal transmission rate, light weight, simple structure and versatile usage. Moreover, the heat can be dissipated without consuming electrical power. However, the working fluid is vaporized after the heat pipe is heated and pressure in the heat pipe is rapidly increased. The vaporized working fluid tends to leak from sealed opening. Therefore, it is important issue to enhance sealing effect for opening of the heat pipe.

The prior art soldering device for heat pipe, for example, Taiwan Patent Application No. 94200338, discloses a soldering device with a transmission unit, a rotation unit and a soldering unit. The transmission unit includes a platform, on which a plurality of heat pipes is disposed and transmitted. A rotation unit is placed atop the platform and includes a rolling wheel in rotational contact with the heat pipe. A solder mechanism is arranged on one side of the transmission unit and includes a solder gun. The solder gun is corresponding to the heat pipe and the rolling wheel, thus soldering the opening of the heat pipe when the heat pipe is in rotational contact with the rolling wheel.

The above-mentioned soldering device can seal end of the heat pipe in mass production manner. The problems of pipe surface damage can be prevented and the problem of hole and thin wall can also be prevented. However, the solder mouth of the solder gun is aligned with the platform during solder process. The soldering error might happen to damage the whole transmission unit due to manual mistake.

### SUMMARY OF THE INVENTION

The present invention is to provides a rotating type soldering device, where solder gun seals heat pipe in rotation when the heat pipe is move away from the transmission platform by feeding rod. Therefore, the problem of wearing and maintenance can be overcome.

Accordingly, the present invention provides a rotating type soldering device, which is used for soldering a heat pipe and includes a transmission mechanism, a rotation mechanism, a material-sending mechanism and a solder mechanism. The transmission mechanism includes a transmission platform on which heat pipes are disposed and transmitted. The rotation mechanism and the material-sending mechanism are arranged on topside and bottom side of the transmission platform. The rotation mechanism includes a pair of rolling wheels rotated in the same direction. The material-sending mechanism includes a feeding rod used to push the heat pipe to move toward the rolling wheels and drive the heat pipe to have rotational contact with the rolling wheels. The solder mechanism is arrange on one side of the heat pipe and includes a solder gun corresponding to one end of the heat pipe and having a height difference with the transmission platform. The solder gun solders an opening of the heat pipe when the heat pipe is in rotational contact with the rolling wheels.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a front view of the present invention before assembling.

FIG. 2 shows a front view of the present invention after assembling.

FIG. 3 is a front view showing the feeding rod being moved upward.

FIG. 4 is a sectional view showing the feeding rod being moved upward.

FIG. 5 is a top view of the solder gun soldering the heat pipe.

FIG. 6 is a sectional view of FIG. 5.

FIG. 7 shows the feeding rod according to another preferred embodiment of the present invention.

### DETAILED DESCRIPTION OF THE INVENTION

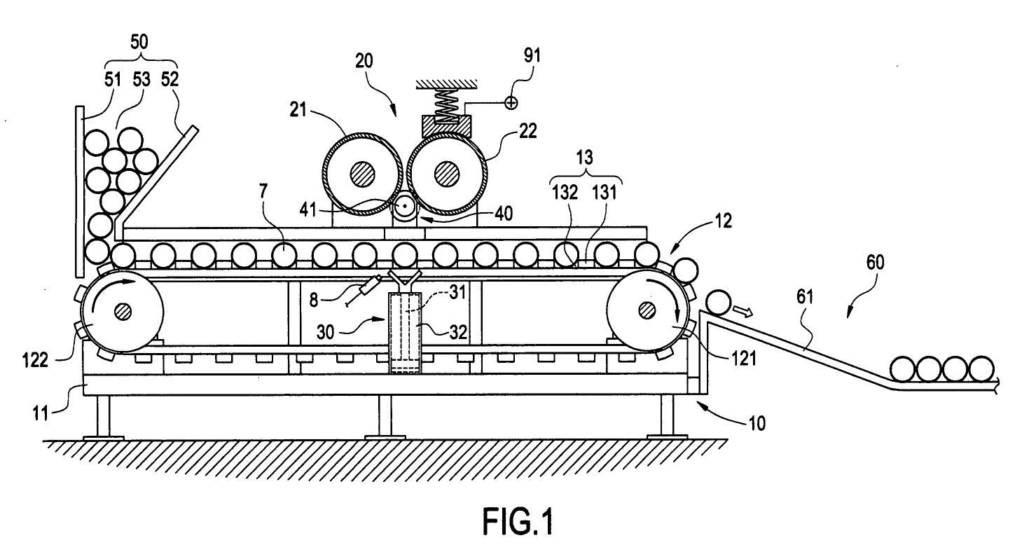

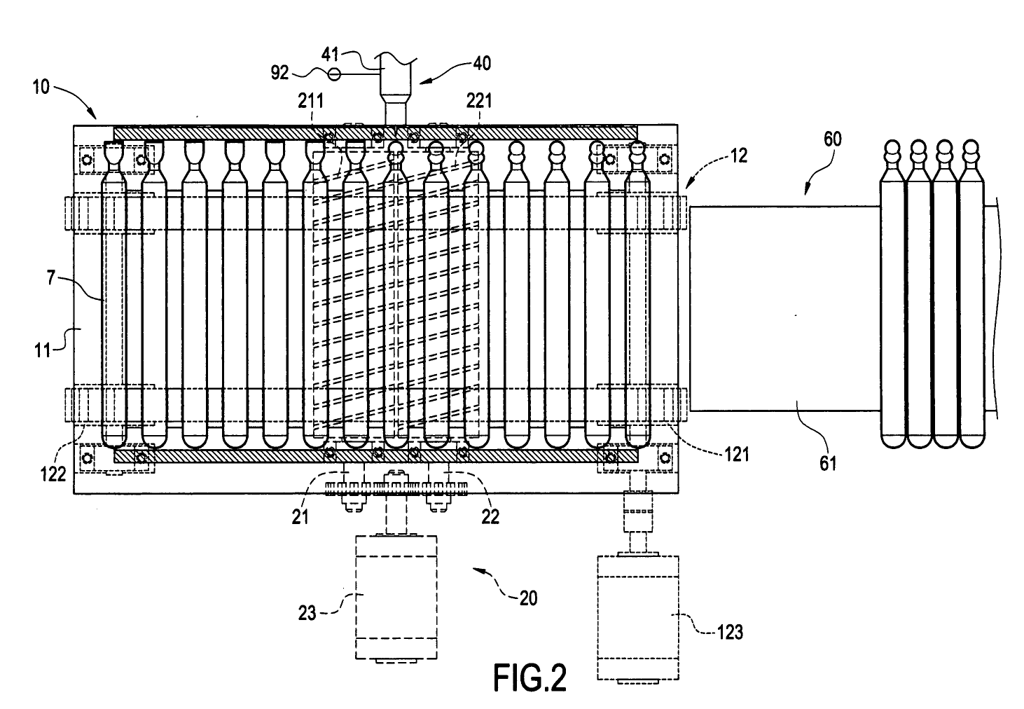

With reference to FIGS. 1 and 2 the present invention provides a rotating type soldering device. The rotating type soldering device according to the present invention can be used to seal an opening end of a heat pipe 7 or a press-closing end of the heat pipe 7. The rotating type soldering device mainly includes a transmission mechanism 10, a rotation mechanism 20, a material-sending mechanism 30 and a solder mechanism 40.

The transmission mechanism 10 includes an elongated rack 11, a power transmission unit 12 arranged on front and rear ends of the elongated rack 11 and a transmission platform 13 fit with the power transmission unit 12. The power transmission unit 12 includes a driving wheel 121 fixed to rear end of the elongated rack 11 and a driven wheel 122 fixed to front end of the elongated rack 11. The driving wheel 121 is connected to a servo motor 123 to drive the transmission platform 13 for intermittent movement. The front end and the rear end of the transmission platform 13 are in parallel arrangement. A plurality of baffle blocks 131 are disposed on the transmission platform 13 and an accommodation groove 132 defined between two adjacent baffle blocks 131 for the placement of the heat pipe 7.

The rotation mechanism 20 is arranged on one side of the transmission platform 13 and fixed to the rear side of the elongated rack 11. The rotation mechanism 20 includes a pair of rolling wheels 21, 22 arranged atop the transmission platform 13 and a driving motor 23 to drive the rolling wheels 21, 22 to rotate in the same direction. The rolling wheels 21, 22 further include slanting grooves 211, 221 on surface thereof and parallel to each other. The slanting grooves 211, 221 generates a lateral pushing force to move the heat pipe 7 along a single direction when the rolling wheels 21, 22 are in rotational contact with the heat pipe 7.

The material-sending mechanism 30 is placed below the transmission platform 13 and corresponding to the rolling wheels 21 and 23. The material-sending mechanism 30 includes a feeding rod 31 and a telescopic unit 32 connected to one end of the feeding rod 31. The feeding rod 31 is of Y shape with an upper opening for accommodating the heat pipe 7 and further includes a bottom portion connected to the telescopic unit 32. The telescopic unit 32 is operated to move the feeding rod 31 upward and downward reciprocally.

The solder mechanism 40 includes a solder gun 41 arranged corresponding to one end of the heat pipe 7 and has a height difference with the transmission platform 13. The solder gun 41 seals opening of the heat pipe 7 when the heat pipe 7 is in rotational contact with the rolling wheels 21 and 22.

The rotating type soldering device of the present invention further includes a material-feeding mechanism 50 and a material-collecting mechanism 60. The material-feeding mechanism 50 includes a longitudinal plate 51 arranged outside the transmission platform 13, a guiding plate 52 arranged on inner side of the longitudinal plate 51 and atop the transmission platform 13, and a material inlet 53 between the longitudinal plate 51 and the guiding plate 52, whereby the heat pipe 7 can be automatically placed into the accommodation groove 132 of the transmission platform 13. The material-collecting mechanism 60 is arranged at rear end of the moving stroke of the transmission platform 13. The material-collecting mechanism 60 includes a slanting plate 61 arranged below the transmission platform 13 and used to collect the heat pipes 7 already finished with solder process.

Moreover, any one of the rolling wheels 21 and 22 is connected to an anode 91 through a spring pressing unit, the solder gun 41 is connected to a cathode 92, thus conducting a solder current.

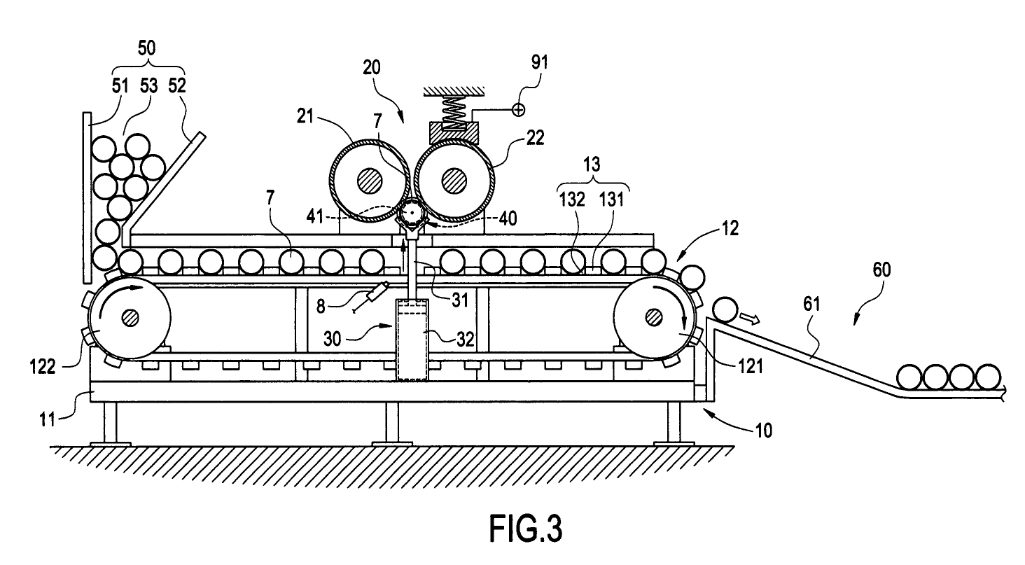

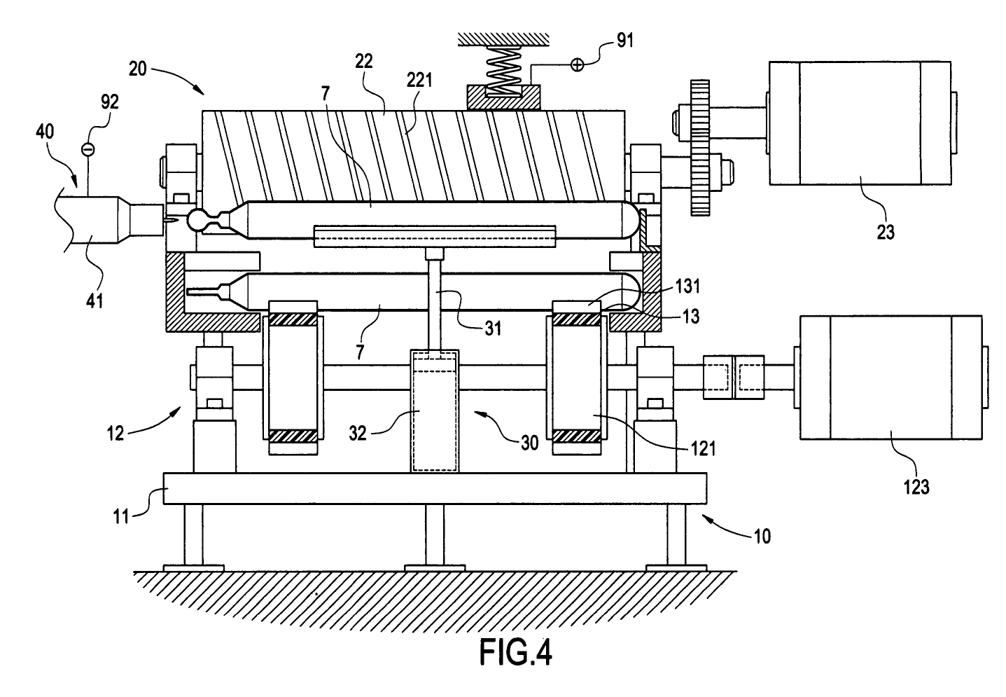

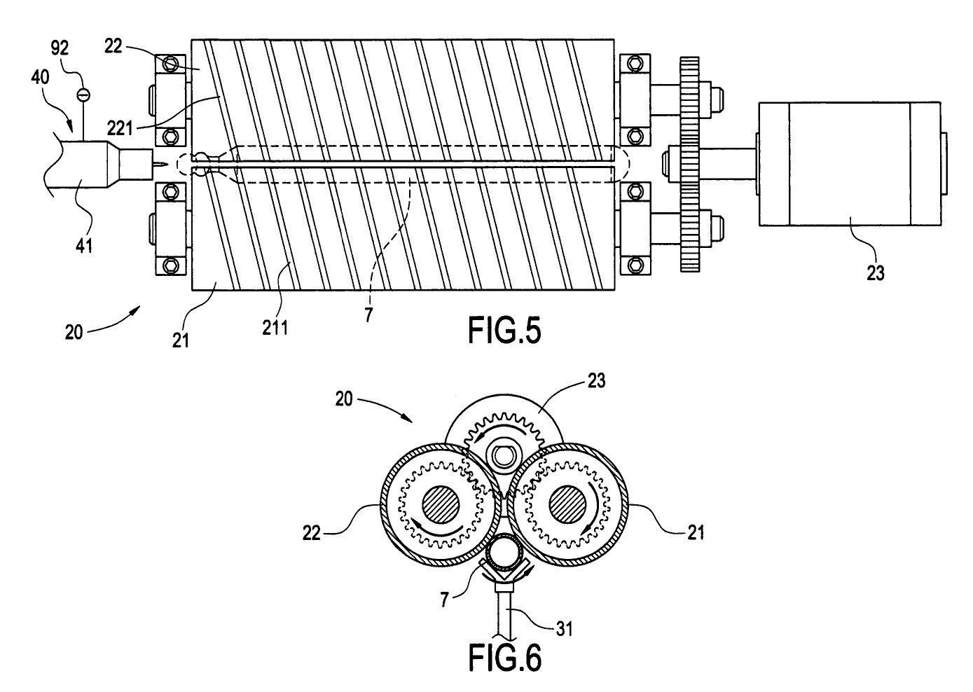

With reference to FIGS. 3 to 6, during solder operation, a plurality of heat pipes 7 are placed in the material inlet 53 of the material-feeding mechanism 50. The servo motor 123 drives the driving wheel 121 to rotate such that the heat pipes 7 fall into the accommodation groove 132 successively. When the heat pipes 7 are moved to a place below the wheels 21 and 22, a sensor 8 sends a signal to the power transmission unit 12 and the servo motor 123 is halted and the telescopic unit 32 operates to drive the feeding rod 31 upward. The heat pipe 7 placed in the accommodation groove 132 is projected atop the transmission platform 13 and the end of the heat pipe 7 to be soldered is even with the solder gun 41 of the solder mechanism 40. At the same time, the motor 23 drives the wheels 21 and 22 to rotate in the same direction. The heat pipe 7 has rotational contact with the wheels 21 and 22 when the heat pipe 7 is in contact with the wheels 21 and 22. Therefore, the solder gun 41 can perform sealing operation to opening of the heat pipe 7. The heat pipe 7 after solder operation is placed again in the accommodation groove 132 and moved to next position by the intermittent rotation of the driving wheel 121. Therefore, the heat pipes can be manufactured in mass production.

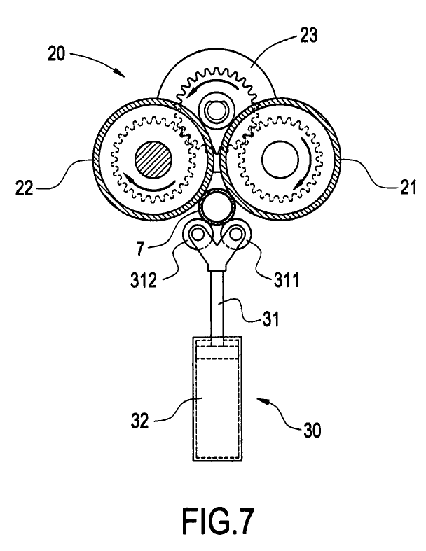

FIG. 7 shows the feeding rod 31 according to another preferred embodiment of the present invention. The feeding rod 31 has Y shaped support at end thereof and a pair of rotational wheels 311 and 312. Therefore, the heat pipe 7 has smooth rotation with the wheels 21 and 22.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A rotating type soldering device for soldering a heat pipe, comprising:
a transmission mechanism comprising a transmission platform on which a plurality of heat pipes are disposed and transmitted;
a rotation mechanism arranged on one side of the transmission platform and comprising a pair of rolling wheels rotated in the same direction;
a material-sending mechanism arranged on another side of transmission platform and corresponding to the rolling wheels of the rotation mechanism, the material-sending mechanism comprising a feeding rod used to push the heat pipe to move toward the rolling wheels and drive the heat pipe to have rotational contact with the rolling wheels; and
a solder mechanism comprising a solder gun corresponding to one end of the heat pipe and having a height difference with the transmission platform, the solder gun soldering an opening of the heat pipe when the heat pipe is in rotational contact with the rolling wheels.

2. The rotating type soldering device as in claim 1, wherein front and rear ends of the transmission platform are parallel.

3. The rotating type soldering device as in claim 1, wherein the transmission mechanism further comprises a rack connected with the transmission platform and a power transmission unit fixed to front and rear ends of the rack, the power transmission unit being fit with the transmission platform and diving the transmission platform for intermittent movement.

4. The rotating type soldering device as in claim 1, wherein the transmission platform is provided with a plurality of baffle blocks and an accommodation groove is defined between two adjacent baffle blocks, the accommodation groove is used to accommodate the heat pipe.

5. The rotating type soldering device as in claim 1, wherein the rolling wheels have slanting grooves on surface thereof.

6. The rotating type soldering device as in claim 1, wherein the rolling wheels are arranged atop the transmission platform and the feeding rod is arranged below the transmission platform, the feeding rod is arranged between two rolling wheels.

7. The rotating type soldering device as in claim 1, wherein the rolling wheels are electrically connected to an anode and the solder gun is electrically connected to a cathode.

8. The rotating type soldering device as in claim 1, wherein the feeding rod is a Y-shaped support.

9. The rotating type soldering device as in claim 8, wherein a pair of rotational wheels are arranged at end of the feeding rod.

10. The rotating type soldering device as in claim 1, wherein the material-sending mechanism further comprises a telescopic unit with one end connected to the feeding rod to drive the feeding rod for upward and downward movement reciprocally.

11. The rotating type soldering device as in claim 1, further comprising a material feeding mechanism arranged at a front end of a movement stroke of the transmission platform.

12. The rotating type soldering device as in claim 11, wherein the material feeding mechanism comprises a longitudinal plate arranged outside the transmission platform, a guiding plate arranged inside the longitudinal plate and atop the transmission platform and a material inlet between the longitudinal plate and the guiding plate.

13. The rotating type soldering device as in claim 11, further comprising a material collecting mechanism arranged at a rear end of a movement stroke of the transmission platform.
